(19) United States
(12) Patent Application Publication
(10) Pub. No.: US 2024/0248827 A1
(43) Pub. Date: Jul. 25, 2024

(54) TOOLS FOR TESTING AUTONOMOUS VEHICLE PLANNERS

(71) Applicant: Five AI Limited, Cambridge (GB)

(72) Inventors: Alejandro Bordallo, Cambridge (GB); Bence Magyar, Cambridge (GB)

(73) Assignee: Five AI Limited, Cambridge (GB)

(21) Appl. No.: 18/564,502

(22) PCT Filed: May 27, 2022
(86) PCT No.: PCT/EP2022/064435

§ 371 Date: Nov. 27, 2023

(30) Foreign Application Priority Data
May 28, 2021 (GB) 2107642.7
May 28, 2021 (GB) 2107644.3
May 28, 2021 (GB) 2107645.0
May 28, 2021 (GB) 2107646.8
Jul. 27, 2021 (GB) 2110797.4

(51) Int. Cl. G06F 11/34; G06F 3/04847; G06F 11/36

(52) U.S. Cl. CPC G06F 11/3457; G06F 3/04847; G06F 11/3684; G06F 11/3688; G06F 11/3692; G06F 11/3696

(57) ABSTRACT

A computer implemented method of evaluating the performance of at least one component of a planning stack for an autonomous robot, the method comprising: generating first evaluation data of a first run by operating the autonomous robot under the control of a planning stack under test in a scenario; modifying at least one operating parameter of at least one component of the planning stack by applying a variable modification to the operating parameter; generating second evaluation data of a second run by operating the autonomous robot under the control of the planning stack in which the at least one operating parameter has been modified, in the scenario; and comparing the first evaluation data with the second evaluation data using at least one performance metric for the comparison.

### FIELD OF INVENTION

The present disclosure relates to tools and techniques for testing the performance of autonomous vehicle planners, and methods, systems and computer programs for implementing the same.

### BACKGROUND

There have been major and rapid developments in the field of autonomous vehicles. An autonomous vehicle is a vehicle which is equipped with sensors and autonomous systems which enable it to operate without a human controlling its behaviour. The term autonomous herein encompass semi-autonomous and fully autonomous behaviour. The sensors enable the vehicle to perceive its physical environment, and may include for example cameras, radar and lidar. Autonomous vehicles are equipped with suitably programmed computers which are capable of processing data received from the sensors and making safe and predictable decisions based on the context which has been perceived by the sensors. There are different facets to testing the behaviour of the sensors and autonomous systems aboard a particular autonomous vehicle, or a type of autonomous vehicle. AV testing can be carried out in the real-world or based on simulated driving scenarios. A vehicle under testing (real or simulated) may be referred to as an ego vehicle or vehicle under test.

One approach to testing in the industry relies on “shadow mode” operation. Such testing seeks to use human driving as a benchmark for assessing autonomous decisions. An autonomous driving system (ADS) runs in shadow mode on inputs captured from a sensor-equipped but human-driven vehicle. The ADS processes the sensor inputs of the human-driven vehicle, and makes driving decisions as if it were notionally in control of the vehicle. However, those autonomous decisions are not actually implemented, but are simply recorded with the aim of comparing them to the actual driving behaviour of the human. “Shadow miles” are accumulated in this manner typically with the aim of demonstrating that the ADS could have performed more safely or effectively than the human.

Existing shadow mode testing has a number of drawbacks. Shadow mode testing may flag some scenarios where the available test data indicates that an ADS would have performed differently from the human driver. This currently requires a manual analysis of the test data. The “shadow miles” for each scenario need to be evaluated in comparison with the human driver miles for the same scenario.

### SUMMARY

According to one aspect of the invention, there is provided a computer implemented method of evaluating the performance of at least one component of a planning stack for an autonomous robot, the method comprising:
generating first evaluation data of a first run by operating the autonomous robot under the control of a planning stack under test in a scenario;
modifying at least one operating parameter of at least one component of the planning stack by applying a variable modification to the operating parameter;
generating second evaluation data of a second run by operating the autonomous robot under the control of the planning stack in which the at least one operating parameter has been modified, in the scenario;
comparing the first evaluation data with the second evaluation data using at least one performance metric for the comparison.

In some embodiments, the at least one component of the planning stack is a perception component, and the variable modification is applied to the accuracy of perception by the perception component.

In some embodiments, the at least one component is a prediction component, and the variable modification is a modification of computational resources accessible for operating the prediction component in the planning stack.

In some embodiments the at least one component is a control component.

In some embodiments, the variable modification is computed based on a statistical distribution of modification values for the parameter being modified. In such an embodiment, the statistical distribution may be a Gaussian distribution.

In some embodiments, the variable modification to the operating parameter is applied responsive to user selection of a modification at a graphical user interface. In such an embodiment, the user selection may comprise activating a slider on the graphical user interface which slides the percentage modification between first and second end points.

In some embodiments, the user selection selects a percentage variable modification to a plurality of the operating parameters.

In some embodiments, the scenario is a simulated scenario. In such an embodiment, the simulated scenario may be based on ground truth extracted from an actual scenario in which the autonomous robot was operated.

In some embodiments, the performance metric uses juncture point recognition. Juncture point recognition is described in our UK patent application GB2107645.0, the contents of which are incorporated herein by reference.

In some embodiments, a result of the comparison is shown as an indication on a performance card. Performance cards are described in our UK patent application GB2107644.3, the contents of which are incorporated herein by reference.

According to a second aspect, there is provided a computer program comprising a set of computer readable instructions, which when executed by a processor, cause the processor to perform a method according to the first aspect or any embodiment thereof.

According to a third aspect, there is provided a non-transitory computer readable medium storing a computer program according to the second aspect.

According to a fourth aspect, there is provided an apparatus comprising a processor; and a code memory storing a set of computer readable instructions, which when executed by the processor cause the processor to: generate first evaluation data of a first run by operating the autonomous robot under the control of a planning stack under test in a scenario; modify at least one operating parameter of at least one component of the planning stack by applying a variable modification to the operating parameter; generate second evaluation data of a second run by operating the autonomous robot under the control of the planning stack in which the at least one operating parameter has been modified, in the scenario; and compare the first evaluation data with the second evaluation data using at least one performance metric for the comparison.

In some embodiments, the at least one component of the planning stack is a perception component, and wherein the variable modification is applied to the accuracy of perception by the perception component.

In some embodiments, the at least one component is a prediction component, and the variable modification is a modification of computational resources accessible for operating the prediction component in the planning stack.

In some embodiments, the at least one component is a control component.

In some embodiments, the variable modification is computed based on a statistical distribution of modification values for the parameter being modified.

In some embodiments, the statistical distribution is a Gaussian distribution.

In some embodiments, the set of computer readable instructions are, when executed by a processor, cause the processor to apply the variable modification to the operating parameter responsive to user selection of a modification at a graphical user interface.

In some embodiments, the user selection comprises activating a slider on the graphical user interface, which slides the percentage modification between first and second end points.

In some embodiments, the user selection selects a percentage variable modification to a plurality of the operating parameters.

In some embodiments, the scenario is a simulated scenario.

In some embodiments, the simulated scenario is based on ground truth extracted from an actual scenario in which the autonomous robot was operated.

In some embodiments, the comparing the first evaluation data with the second evaluation data uses juncture point recognition.

In some embodiments, the set of computer readable instructions are configured to, when executed by the processor, cause the processor to display the result of the comparison as an indication on a performance card.

### BRIEF DESCRIPTION OF FIGURES

For a better understanding of the present invention and to show how the same may be carried into effect, reference will now be made by way of example to the accompanying drawings in which:

FIG. 1 shows a highly schematic block diagram of a runtime stack for an autonomous vehicle.

FIG. 2 shows a highly schematic block diagram of a testing pipeline for an autonomous vehicle's performance during simulation.

FIG. 3 shows a highly schematic block diagram that represents an exemplary scenario extraction pipeline.

FIG. 4 shows a flowchart that demonstrates a process wherein a visual indication of improvement potential is assigned to a run.

FIG. 5 shows a flowchart that demonstrates a process wherein continuous ablation of a reference planner is performed iteratively to compare the performance of two robot stacks.

FIG. 6 shows a flowchart that demonstrates a process of generating a requirements specification for a stack under test.

FIG. 7 shows a highly schematic block diagram of a computer system configured to test autonomous vehicle planners.

### DETAILED DESCRIPTION

A performance evaluation tool is described herein, that enables different planning stacks or planning stack components (or ‘slices’) to be compared. A planning stack may be referred to herein as an Autonomous Vehicle (AV) stack. A technique referred to as “continuous ablation” is introduced. “Continuous ablation” refers to a process of intentionally varying the value or error of one or more operating parameter in a first planning stack or planning stack component, in order to enable a comparison between performance of the first planning stack with the performance of a second planning stack, or planning stack component. An example of such an operating parameter may be a perception parameter such as field of view or distance measurements. Another example of an operating parameter may be a computational resource parameter, such as simulation latency. Note that it is the error in a perception parameter that is ablated. That is, a real stack will measure distances and other similar parameters using a perception component, wherein those measurements will include some amount of error. It is the amount of error in such a perception parameter that is ablated. However, parameters such as compute budget and simulation latency, which are inherent properties of a particular stack, may be ablated by changing the actual value, rather than error therein.

Analysis of performance may be done by analysing features of ‘runs’. Using continuous ablation of operating parameters may allow a user to identify parameter value boundaries at which one planning stack begins to outperform another. Such analysis may provide insight into the type and extent of improvements of which a planning stack is susceptible.

Before describing the above features in detail, an overview of the system in which they may be implemented will first be provided.

### Example AV Stack

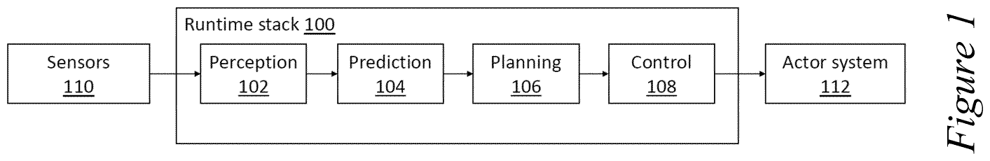

FIG. 1 shows a highly schematic block diagram of a runtime stack 100 for an autonomous vehicle (AV), also referred to herein as an ego vehicle (EV). The run time stack 100 is shown to comprise a perception system 102, a prediction system 104, a planner 106 and a controller 108.

In a real-world context, the perception system 102 would receive sensor inputs from an on-board sensor system 110 of the AV and uses those sensor inputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion sensor(s) (accelerometers, gyroscopes etc.) etc., which collectively provide rich sensor data from which it is possible to extract detailed information about the surrounding environment and the state of the AV and any external actors (vehicles, pedestrians, cyclists etc.) within that environment. The sensor inputs typically comprise sensor data of multiple sensor modalities such as stereo images from one or more stereo optical sensors, lidar, radar etc.

The perception system 102 comprises multiple perception components which co-operate to interpret the sensor inputs and thereby provide perception outputs to the prediction system 104. External agents may be detected and represented probabilistically in a way that reflects the level of uncertainty in their perception within the perception system 102.

The perception outputs from the perception system 102 are used by the prediction system 104 to predict future behaviour of external actors (agents), such as other vehicles in the vicinity of the AV. Other agents are dynamic obstacles from the perceptive of the EV. The outputs of the prediction system 104 may, for example, take the form of a set of predicted of predicted obstacle trajectories.

Predictions computed by the prediction system 104 are provided to the planner 106, which uses the predictions to make autonomous driving decisions to be executed by the AV in a given driving scenario. A scenario is represented as a set of scenario description parameters used by the planner 106. A typical scenario would define a drivable area and would also capture any static obstacles as well as predicted movements of any external agents within the drivable area. A core function of the planner 106 is the planning of trajectories for the AV (ego trajectories) taking into account any static and/or dynamic obstacles, including any predicted motion of the latter. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown). In the following examples, a goal is defined by a fixed or moving goal location and the planner 106 plans a trajectory from a current state of the EV (ego state) to the goal location. For example, this could be a fixed goal location associated with a particular junction or roundabout exit, or a moving goal location that remains ahead of a forward vehicle in an overtaking context. A trajectory herein has both spatial and motion components, defining not only a spatial path planned for the ego vehicle, but a planned motion profile along that path. The planner 106 is required to navigate safely in the presence of any static or dynamic obstacles, such as other vehicles, bicycles, pedestrians, animals etc.

Returning to FIG. 1, within the stack 100, the controller 108 implements decisions taken by the planner 106. The controller 108 does so by providing suitable control signals to an on-board actor system 112 of the AV. At any given planning step, having planned an instantaneous ego trajectory, the planner 106 will provide sufficient data of the planned trajectory to the controller 108 to allow it to implement the initial portion of that planned trajectory up to the next planning step. For example, it may be that the planner 106 plans an instantaneous ego trajectory as a sequence of discrete ego states at incrementing future time instants, but that only the first of the planned ego states (or the first few planned ego states) are actually provided to the controller 108 for implementing.

In a physical AV, the actor system 112 comprises motors, actuators or the like that can be controlled to effect movement of the vehicle and other physical changes in the real-world ego state.

Control signals from the controller 108 are typically low-level instructions to the actor system 112 that may be updated frequently. For example, the controller 108 may use inputs such as velocity, acceleration, and jerk to produce control signals that control components of the actor system 112. The control signals could specify, for example, a particular steering wheel angle or a particular change in force to a pedal, thereby causing changes in velocity, acceleration, jerk etc., and/or changes in direction.

### Simulation Testing—Overview

Embodiments herein have useful applications in simulation-based testing. Referring to the stack 100 by way of example, in order to test the performance of all or part of the stack 100 though simulation, the stack is exposed to simulated driving scenarios. The examples below consider testing of the planner 106—in isolation, but also in combination with one or more other sub-systems or components of the stack 100.

In a simulated driving scenario, an ego agent implements decisions taken by the planner 106, based on simulated inputs that are derived from the simulated scenario as it progresses. Typically, the ego agent is required to navigate within a static drivable area (e.g. a particular static road layout) in the presence of one or more simulated obstacles of the kind a real vehicle needs to interact with safely. Dynamic obstacles, such as other vehicles, pedestrians, cyclists, animals etc. may be represented in the simulation as dynamic agents.

The simulated inputs are processed in exactly the same way as corresponding physical inputs would be, ultimately forming the basis of the planner's autonomous decision making over the course of the simulated scenario. The ego agent is, in turn, caused to carry out those decisions, thereby simulating the behaviours of a physical autonomous vehicle in those circumstances. In simulation, those decisions are ultimately realized as changes in a simulated ego state. There is this a two-way interaction between the planner 106 and the simulator, where decisions taken by the planner 106 influence the simulation, and changes in the simulation affect subsequent planning decisions. The results can be logged and analysed in relation to safety and/or other performance criteria.

Turning to the outputs of the stack 100, there are various ways in which decisions of the planner 106 can be implemented in testing. In “planning-level” simulation, the ego agent may be assumed to exactly follow the portion of the most recent planned trajectory from the current planning step to the next planning step. This is a simpler form of simulation that does not require any implementation of the controller 108 during the simulation. More sophisticated simulation recognizes that, in reality, any number of physical conditions might cause a real ego vehicle to deviate somewhat from planned trajectories (e.g. because of wheel slippage, delayed or imperfect response by the actor system, or inaccuracies in the measurement of the vehicle's own state 112 etc.). Such factors can be accommodated through suitable modelling of the ego vehicle dynamics. In that case, the controller 108 is applied in simulation, just as it would be in real-life, and the control signals are translated to changes in the ego state using a suitable ego dynamics model (in place of the actor system 112) in order to more realistically simulate the response of an ego vehicle to the control signals.

In that case, as in real life, the portion of a planned trajectory from the current planning step to the next planning step may be only approximately realized as a change in ego state.

### Example Testing Pipeline

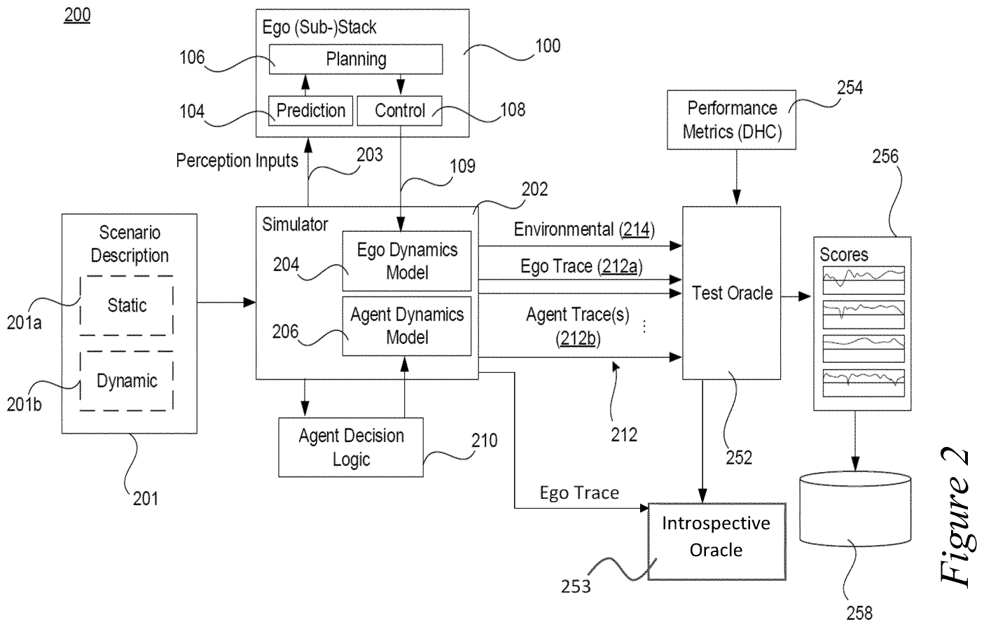

FIG. 2 shows a schematic block diagram of a testing pipeline 200. The testing pipeline is highly flexible and can be accommodate many forms of AV stack, operating at any level of autonomy. As indicated, the term autonomous herein encompasses any level of full or partial autonomy, from Level 1 (driver assistance) to Level 5 (complete autonomy).

The testing pipeline 200 is shown to comprise a simulator 202, a test oracle 252 and an ‘introspective’ oracle 253. The simulator 202 runs simulations for the purpose of testing all or part of an AV run time stack.

By way of example only, the description of the testing pipeline 200 makes reference to the runtime stack 100 of FIG. 1 to illustrate some of the underlying principles by example. As discussed, it may be that only a sub-stack of the run-time stack is tested, but for simplicity, the following description refers to the AV stack 100 throughout; noting that what is actually tested might be only a subset of the AV stack 100 of FIG. 1, depending on how it is sliced for testing. In FIG. 2, reference numeral 100 can therefore denote a full AV stack or only sub-stack depending on the context.

FIG. 2 shows the prediction, planning and control systems 104, 106 and 108 within the AV stack 100 being tested, with simulated perception inputs 203 fed from the simulator 202 to the stack 100.

The simulated perception inputs 203 are used as a basis for prediction and, ultimately, decision-making by the planner 108. However, it should be noted that the simulated perception inputs 203 are equivalent to data that would be output by a perception system 102. For this reason, the simulated perception inputs 203 may also be considered as output data. The controller 108, in turn, implements the planner's decisions by outputting control signals 109. In a real-world context, these control signals would drive the physical actor system 112 of AV. The format and content of the control signals generated in testing are the same as they would be in a real-world context. However, within the testing pipeline 200, these control signals 109 instead drive the ego dynamics model 204 to simulate motion of the ego agent within the simulator 202.

A simulation of a driving scenario is run in accordance with a scenario description 201, having both static and dynamic layers 201a, 201b.

The static layer 201a defines static elements of a scenario, which would typically include a static road layout.

The dynamic layer 201b defines dynamic information about external agents within the scenario, such as other vehicles, pedestrians, bicycles etc. The extent of the dynamic information provided can vary. For example, the dynamic layer 201b may comprise, for each external agent, a spatial path to be followed by the agent together with one or both of motion data and behaviour data associated with the path.

In simple open-loop simulation, an external actor simply follows the spatial path and motion data defined in the dynamic layer that is non-reactive i.e. does not react to the ego agent within the simulation. Such open-loop simulation can be implemented without any agent decision logic 210.

However, in “closed-loop” simulation, the dynamic layer 201b instead defines at least one behaviour to be followed along a static path (such as an ACC behaviour). In this, case the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 110 might be permitted to reduce the speed of the external agent below the target at any point along the path in order to maintain a target headway from a forward vehicle.

The output of the simulator 202 for a given simulation includes an ego trace 212a of the ego agent and one or more agent traces 212b of the one or more external agents (traces 212).

A trace is a complete history of an agent's behaviour within a simulation having both spatial and motion components. For example, a trace may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “environmental” data 214 which can have both static components (such as road layout) and dynamic components (such as weather conditions to the extent they vary over the course of the simulation).

To an extent, the environmental data 214 may be “passthrough” in that it is directly defined by the scenario description 201 and is unaffected by the outcome of the simulation. For example, the environmental data 214 may include a static road layout that comes from the scenario description 201 directly. However, typically the environmental data 214 would include at least some elements derived within the simulator 202. This could, for example, include simulated weather data, where the simulator 202 is free to change weather conditions as the simulation progresses. In that case, the weather data may be time-dependent, and that time dependency will be reflected in the environmental data 214.

The test oracle 252 receives the traces 212 and the environmental data 214, and scores those outputs against a set of predefined numerical metrics 254. The metrics 254 may encode what may be referred to herein as a “Digital Highway Code” (DHC) or digital driving rules. Some examples of other suitable performance metrics are given below.

The scoring is time-based: for each performance metric, the test oracle 252 tracks how the value of that metric (the score) changes over time as the simulation progresses. The test oracle 252 provides an output 256 comprising a score-time plot for each performance metric.

The metrics 254 are informative to an expert and the scores can be used to identify and mitigate performance issues within the tested stack 100.

The introspective oracle 253 is a computer system configured to utilise information (such as the above metrics) from real runs or simulated runs taken by an ego robot. The information may be used to provide insight into the performance of a stack under test.

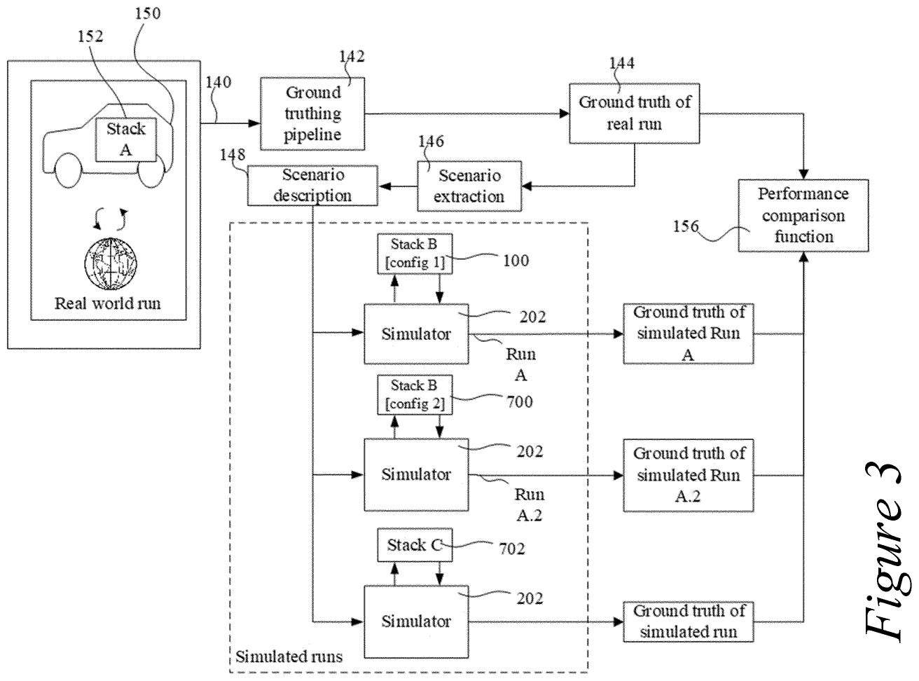

Analysis using continuous ablation is particularly useful in enabling a user to understand the performance of their planning stack (or certain portions of his planning stack). For this application, details of a user run are required. FIG. 3 shows a highly schematic block diagram of a scenario extraction pipeline. Run data 140 of a real-world run is passed to a ground truthing pipeline 142 for the purpose of generating scenario ground truth. The run data 140 could comprise for example sensor data and/or perception outputs captured/generated onboard one or more vehicles (which could be autonomous, human driven or a combination thereof), and/or data captured from other sources such as external sensors (CCTV etc.). As shown in FIG. 3, the run data 140 is shown provided from an autonomous vehicle 150 running a planning stack 152 which is labelled stack A. The run data is processed within the ground truthing pipeline 142 in order to generate appropriate ground truth 144 (trace(s) and contextual data) for the real-world run. The ground truthing process could be based on manual annotation of the raw run data 142 or the process could be entirely automated (e.g. using offline perception methods), or a combination of manual and automated ground truthing could be used. For example, 3D bounding boxes may be placed around vehicle and/or other agents captured in the run data 140 in order to determine spatial and motion states of their traces. A scenario extraction component 146 receives the scenario ground truth 144 and processes the scenario ground truth to extract a more abstracted scenario description 148 that can be used for the purpose of simulation. The scenario description is supplied to the simulator 202 to enable a simulated run to be executed. In order to do this, the simulator 202 may utilize a stack 100 which is labelled stack B, config 1. The relevance of this is discussed in more detail later. Stack B is the planner stack, which is being used for comparison purposes, to compare its performance against the performance of stack A, which was run in the real run. Stack B could be for example a reference planner stack, of which one or more component is subject to ablation, as described further herein. Planner stack B may be ablated such that it performs under highly realistic operating constraints, highly artificial operating constraints, or constraints of some level of realism therebetween.

Actual run data may be compared against the simulated output of an ablated reference planner stack, the reference planner stack performing at a user-defined level of realism between optimally artificial and optimally realistic with respect to the real run. Note, therefore, that an optimally realistic output would exactly model the output of the actual run data, as represented by the ground truth data. The run data from the simulation, which may be an output run of an ablated reference planner stack, is supplied to a performance comparison function 156. The ground truth actual run data is also supplied to the performance comparison function 156. The performance comparison function 156 determines whether there is a difference in performance between the real run and the simulated run. This may be done in a number of different ways, as further described herein. One novel technique discussed herein and discussed in UK patent application no: GB2107645.0 is juncture point recognition.

As illustrated in FIG. 3, there may be more than one simulation run performed in order to get a performance improvement reference. There may multiple different planner solutions that can be run in simulation on this particular scenario, and the best performing of them may be the one against which the performance of stack A is compared to generate the visual indication on the card. For example, as shown in FIG. 3, a simulated run could be using the simulator 202 using stack B config 2 700, (that is, the same stack as in the first simulation but with the different configuration of certain parameters). Note that the different configuration of parameters could imply that one or more operating parameter of the stack is ablated, thereby injecting a certain level of realism into the planner. Alternatively, the simulation could be run with a different stack, for example labelled stack C 702.

In embodiments of the present invention, the effect of different operating parameters can be analysed by ablating the parameters of planners and planning stack components or slices, and comparing runs executed with different levels of ablation. Ablation of operating parameters, particularly continuous ablation, is now described in more detail.

There are various configurable operating parameters that can alter the operating conditions of an autonomous robot stack in a testing environment. The operating parameters may pertain to different ‘levels’ (components) of the stack. Examples of an operating parameter may include perception parameters such as field of view, computational resources such as simulation latency, and error in measurements made by a robot. Changes made to an such an operating parameter of a stack may cause changes to an output run in a particular simulated scenario. More than one operating parameter may be varied at once; for example, two or more parameters of the perception, prediction, planning components etc.

In one example application, perception systems of a planning stack may be tested by ablation of operating parameters. The manner in which the stack is “sliced” for testing determines the form of simulated perception inputs that need to be provided to the slice (stack/sub-stack). When testing a perception system, the stack may be sliced for testing, such that at least a portion of the perception system is not running in testing. Instead of running the whole perception system, simulator ground truth data may be used, the simulator ground truth data providing a notionally perfect representation of a simulated environment or scenario, wherein operating parameters such as computational budget are optimised and error (such as perception error) is zero. A statistical model of the perception system, or the subset of the perception system that has been sliced, may then be used to ablate the operating parameters of the simulator, introducing perception errors inherent to the perception system to the ground truth data.

Binary ablation is the variation of operating parameters to produce runs at either extreme of accuracy. That is, a “perfect” ground truth output may be ablated to produce an output that is fully representative of the realistic perception errors of which a sliced or statistically modelled perception system would be susceptible. Binary ablation is described in our PCT patent application No PCT/EP2020/073563, the contents of which are incorporated by reference. By contrast, continuous ablation refers to the variation of operating parameters in a continuous manner, such that operating parameters and measurement error may take values that lie somewhere between the extremes of artificial ground truth accuracy and the realistic values inherent to a particular stack or slice thereof. For example, an operating parameter may take numerical values which, when varied in a continuous manner, may cause continuous increase or decrease in the extent to which an output demonstrates the behaviour of either the stack under test or the reference planner. Perception error in a particular measurement, for example, may be varied between the highly accurate artificial simulator ground truth, and the realistic error inherent to the modelled or sliced perception system. It will be appreciated, therefore, that continuous ablation of operating parameters allows control of the “realism” of an output; the more error introduced, the more the output will match the performance of a realistic test stack output with respect to the ablated operating parameter.

The following description relates to an existing system developed by the present applicant, the system capable of modelling the perception error of which a stack under test (or slice thereof) is susceptible. These systems are known as “PSPMs” and are described in our UK Application no. 1912145.8, the contents of which are incorporated by reference. PSPMs (Perception Statistical Performance Models) model perception errors in terms of probabilistic uncertainty distributions, based on a robust statistical analysis of actual perception outputs computed by a perception component or components being modelled. A unique aspect of PSPMs is that, given a perception ground truth (i.e. a “perfect” perception output that would be computed by a perfect but unrealistic perception component), a PSPM provides a probabilistic uncertainty distribution that is representative of realistic perception components that might be provided by the perception component(s) it is modelling. For example, given a ground truth 3D bounding box, a PSPM which models a PSPM modelling, a 3D bounding box detector will provide an uncertainty distribution representative of realistic 3D object detection outputs. Even when a perception system is deterministic, it can be usefully modelled as stochastic to account for epistemic uncertainty of the many hidden variables on which it depends on practice.

Perception ground truths will not, of course, be available at runtime in a real-world AV (this is the reason complex perception components are needed that can interpret imperfect sensor outputs robustly). However, perception ground truths can be derived directly from a simulated scenario run in a simulator. For example, given a 3D simulation of a driving scenario with an ego vehicle (the simulated AV being tested) in the presence of external actors, ground truth 3D bounding boxes can be directly computed from the simulated scenario for the external actors based on their size and pose (location and orientation) relative to the ego vehicle. A PSPM can then be used to derive realistic 3D bounding object detection outputs from those ground truths, which in turn can be processed by the remaining AV stack just as they would be at runtime.

### Continuous Ablation

In some embodiments, a continuous range between 0 and 1 may be mapped to the error in a perception parameter, where a value of 0 in the range may impose maximally artificial error constraints on the operating parameter. Conversely, a value of 1 in the range may impose maximally realistic error constraints on the operating parameter.

A system of scaling the error is therefore implemented to impose error constraints for continuous values of 0<x<1 in the range. In some embodiments a Gaussian distribution (herein referred to as the Gaussian), from which errors are sampled, may be applied. For example, the Gaussian may be a probabilistic function of an error variable, the Gaussian centred on the error of the ground truth system. An increase or decrease in the value in the range may incur a corresponding widening or narrowing of the Gaussian curve.

In such an embodiment, for a value in the range of 0, the Gaussian may exactly model the error of which the stack slice or modelled system is susceptible. At a value in the range of 0<x<1, the Gaussian may have a reduced covariance compared to the curve at the value 0; the curve may therefore be narrower and may restrict the extent to which the error deviates from the artificial ground truth minimum error. Using a change in covariance to vary the realism of outputs represents a continuous ablation of operation parameters.

At a value in the range of 1, the Gaussian be infinitely narrow, such that an output does not deviate from the ground truth, thereby reproducing the ground truth output. For example, the Gaussian at a value in the range of 1 may be a function:

$$G ( T ) = \{ \begin{matrix}0 \to T \neq {T}_{0} \\ 1 \to T = {T}_{0}\end{matrix} ,$$

where T₀ is a constant that represents the artificial ground truth minimum error, and T represents the arbitrary error variable. As seen in the equation above, wherein it is assumed that the value in the range is 1, the probability G(T) of the error being equal to the notionally minimal ground truth error is 1, so the system recreates the ground truth output. Note that other functions, and ranges other than [0,1], may be used to control the introduction of realism into a stack under test, or slice thereof, the Gaussian described above is given by way of example.

In another example, a range between 0 and 1 may be mapped to a computational resource parameter such as a compute budget. For example, a value of 0 in the range may allow unlimited computational resources during simulation. Conversely, a value of 1 in the range may impose maximally realistic computational budget constraints with respect to the stack under test during simulation.

The above exemplary implementation of continuous ablation relates to ablation of a perception parameter. Recall that a real stack measures distances and other similar parameters using a perception component, wherein those measurements include some amount of error. In the above example, it is the amount of error in the perception parameter that is changed when the Gaussian widens or narrows. However, it will be appreciated that parameters such as compute budget and simulation latency, which are inherent properties of a particular stack, may also be mapped to a range between 0 and 1, where a value of 0 in the range assigns a maximally artificial value of the parameter and a value of 1 in the range assigns a maximally realistic value of the parameter. Direct continuous ablation of a parameter value (as opposed to error in a measured value) may be done by sampling a value from a Gaussian distribution, in accordance with the method described above. Note that in some embodiments, a different function may be used to map the value in the slider to a parameter value.

### Realism Sliders

In some embodiments, a range as described above may be mapped to more than one operating parameter. For example, a range between 0 and 1 may be mapped to one or more perception parameter and/or to one or more resource-based parameter, such as compute budget. In an embodiment where the range is mapped to multiple parameters, a modification to the value in the range may cause ablation of all parameters to which the range is mapped. This allows a user to introduce realism with respect to all relevant operating parameters simultaneously. A tool configured to set a value in a range to determine the extent of realism introduced with respect to one or more parameters may be referred to herein as a realism slider. A realism slider may be rendered as an interactive feature of a graphical user interface used to control the reference planner, the slider having a selectable handle which is moved from left to right to assign a value in the range. In some embodiments, a realism slider may be mapped to multiple operating parameters, for example, one or more perception parameter and/or resource-based parameter. As the slider moves between the extremes of the range, the realism of the output of the reference planner is modified with respect to all parameters to which the slider is mapped, thereby adjusting multiple facets of reality simultaneously. For example, if the realism slider sets a value of 0, the output of the reference planner exactly models the performance of the stack (or slice thereof) under test. As the handle of the realism slider moves and sets a value greater than 0, the parameters to which the slider is mapped are ablated, and the realism of the reference planner output is increased with respect to those parameters. Each facet of reality is represented by one or more operating parameter.

### Performance Card Implementation

The techniques described herein have a number of different applications.

One application is to generate so-called performance cards. Performance cards are novel performance evaluation tools developed by the present applicant and described in our UK patent application GB2107644.3, the contents of which are incorporated by reference.

One way of carrying out a performance comparison is to generate a so-called “performance card”. A performance card is generated to provide an accessible indication of the performance of a particular planning stack (or particular portions of a planning stack). A performance card is a data structure comprising a plurality of performance indicator regions, each performance indicator region indicating a performance parameter associated with a particular run. The performance indicator regions are also referred to herein as tiles. A performance card is capable of being visually rendered on a display of a graphical user interface to allow a viewer to quickly discern the performance parameter for each tile. Each tile comprises a particular visual representation selected from a quantised set of visual representations. The visual representation displayed in each tile is determined based on a performance comparison between a run as performed by a stack under test and the same run as performed by a reference planner, the reference planner operating with zero perception error and effectively unlimited computational resource.

The performance difference of the runs may be used to generate a visual indication for a tile associated with this run in a performance card. If there was no difference, a visual indication indicating that no improvement has been found is provided (for example, dark green). This means that the comparison system has failed to find any possible improvement for this scenario, even when run against a reference planner stack. This means that the original planner stack A performed as well as it could be expected to, or that no significant way could be found to improve its performance. This information in itself is useful to a user of stack A.

If a significant difference is found in the performance between the real run and the simulated run, an estimate may be made of how much the performance could be improved. A visual indication may be provided for each level of estimate in a quantized estimation scale.

An exemplary application of continuous ablation in context of providing performance comparisons between a stack under test and a reference stack is now described with reference to the performance card functionality.

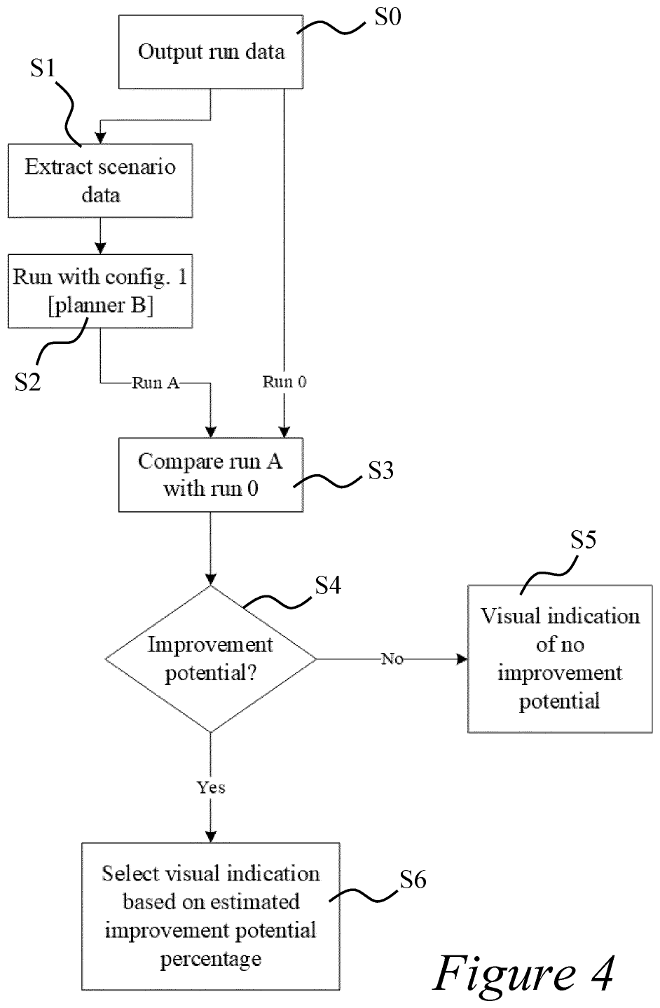

An exemplary workflow for generating a performance card is shown in FIG. 4, wherein a visual indicator assigned to a tile of a performance card is determined based on a comparison of the performance of a stack under test with the performance of a reference planner for a particular run. At step S0, the output run data 140 is provided. At Step S1, scenario data is extracted from the output run data as described herein with reference to FIG. 3. At Step S2, the extracted scenario data is run in the simulator using planner stack B (possibly in a certain configuration, config 1). The output of the simulator is labelled run A in FIG. 4. The real world run data is labelled run 0 in FIG. 4. At step S3, the data of run A is compared with the data of run 0 to determine the difference in performance between the runs. At step S4, it is determined whether or not there is any potential for improvement, based on the difference in performance. If there is not, a visual indication indicating no improvement potential is provided at step S5. If there is improvement potential, an estimate of the improvement potential is generated, and the visual indication selected based on that estimate at step S6.

A performance card may be presented to a user as an interactive feature on a graphical user interface. The user may interact with the performance card by selecting a tile corresponding to a particular run. For example, a user may select a tile which comprises a visual indicator which indicates that the run associated with the selected tile is susceptible of major or extreme improvement compared to the reference planner.

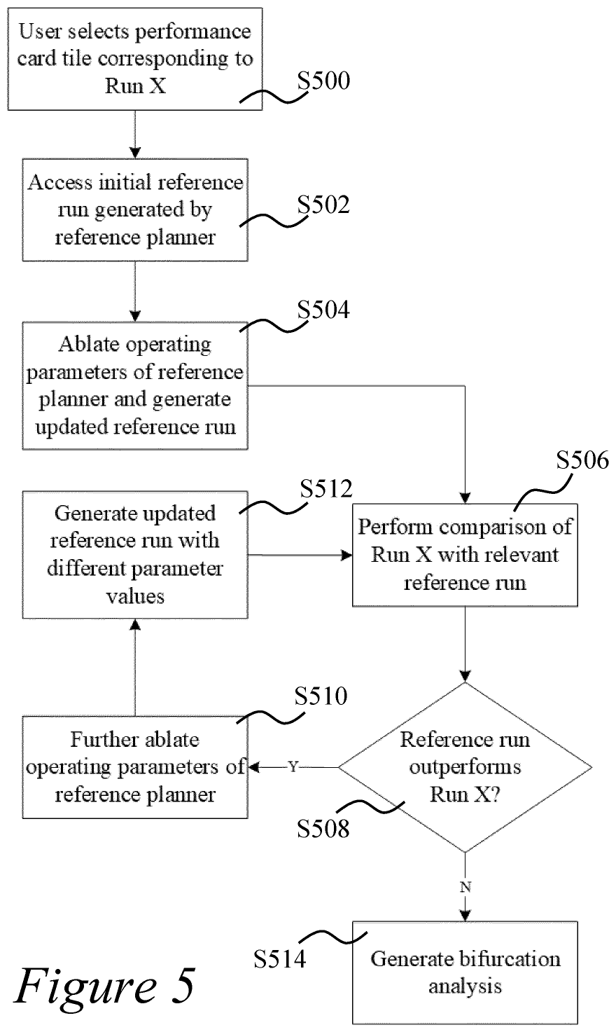

FIG. 5 shows a flowchart which demonstrates an exemplary process initiated upon selection of a particular performance card tile, which uses continuous ablation to provide further insight into the improvement potential of a particular run performed by a stack under test (SUT). In the exemplary process of FIG. 5, continuous ablation of one or more operating parameter of a reference planner is followed by simulation and comparison with the SUT run. The process is repeated in an iterative fashion, such that the reference planner is gradually “injected” with increased realism with each iteration. After one or more iterations, a bifurcation point may be identified at which the SUT output outperforms the output of the ablated reference planner.

FIG. 5 begins at a step S500, wherein a user selects a particular tile of a performance card, the selected tile corresponding to a run of a scenario which, when compared against a reference run of the same scenario produced by a reference planner, has been deemed to be susceptible of at least some improvement. The run produced by the stack under test is referred to in this example as “Run X”. Upon selection of the tile, a series of simulations and subsequent performance comparisons are carried out iteratively. At a step S502, the initial reference run generated by the reference planner against which Run X was deemed susceptible of improvement is accessed. In a step S504, ablation of one or more operating parameter of the reference planner is performed. For example, the ablation may cause increase in the error of one or more perception parameters and/or a decrease in computational budget such that a subsequent output of the reference planner is affected to some extent by the performance limitations of the SUT. A simulation by the reference planner using the one or more ablated operating parameter is then performed.

In a step S506, a comparison is performed between Run X and output of the reference planner, the output of the reference planner being affected by ablation of operating parameters therein; the comparison may be based on one or more performance metric. In a step S508, a determination of whether the reference run has outperformed Run X is performed. If it is deemed that the reference run outperforms Run X, the flow continues to step S510, wherein the one or more operating parameter of the reference planner is further ablated. The ablation at step S510 may cause further increase in the error of one or more perception parameter, and/or may reduce computational resources available to the reference planner. An updated reference run is then generated in a step S512, the updated reference run based on operating parameters as determined in step S510. The flow then returns to step S506, wherein the updated reference run is again compared with Run X. The steps S506, S508, S510 and S512 may form a loop, wherein after one or more iterations of the loop, a bifurcation point is identified at which the reference run no longer outperforms Run X with respect to the one or more performance metrics.

When, at step S508, it is determined that the reference run is outperformed by Run X under the one or more performance metric, the flow continues to a step S514, wherein analysis of the results of the process may be provided to the user, for example on a user interface of a display device. The analysis may show, for example, that the reference planner is capable of generating a run that outperforms Run X even with realistic operating parameter values and errors, in which case the stack under test is susceptible of improvement, even under realistic operating conditions. Alternatively, the analysis may show that the reference planner only outperforms the stack under test under highly artificial operating conditions.

Note that the exemplary process described above implements an incremental increase in realism with each iteration. However, a different method of ablating the one or more operating parameter may be implemented. In some embodiments, the method by which the parameters are ablated after each iteration of the loop S506-S512 implements a realism slider with a range of 0-1, wherein the realism slider range is mapped to one or more operating parameter. Step S504 may cause ablation of the operating parameters by moving the realism slider to a value of ½, such that the realism of the resulting reference run is halfway between that of the stack under test and that of the reference planner. A determination at step S508 that the reference run outperforms Run X indicates that a bifurcation point p, at which the reverse becomes true, is at a value on the slider of

$$0 < p < \frac{1}{2} .$$

In the next iteration of the loop S506-S512, the ablation may set the slider to a value of ¼: halfway between the value of zero and the lowest known slider value at which the reference planner outperforms Run X. Consider that a slider value of ¼ causes generation of a run that is determined to be outperformed by Run X. In such a case, it is known that the bifurcation point p at which Run X begins to outperform the reference run lies at a value of

$$\frac{1}{4} < p < \frac{1}{2}$$

on the slider. It will be appreciated that further iterations of the loop reduce the size of the region of the range in which the bifurcation point is known to exist. For example, in the above example, the next iteration may set a slider value of ⅜, halfway between ¼ and ½. A determination that reference run performs better or worse than Run X in this iteration infers either that the bifurcation point p lies within the value regions

$$\frac{3}{8} < p < \frac{1}{2}$$

on the slider (if Run X performs better than the reference run), or the region

$$\frac{1}{4} < p < \frac{3}{8}$$

(if Run X performs worse than the reference run). Other ways of ablating operating parameters may exist, and the above is provided by way of example only.

### Ablation of a Stack Under Test

Another application of continuous ablation is to develop a requirements specification for a stack under test. That is, an SUT may have ‘failed’ on a particular run (e.g. based on some driving rule/combination of driving rules, or based on a performance comparison with a reference planner). In such a case, different combinations of operating parameters of the SUT may be analysed using iterative continuous ablation, performing a performance analysis on the output of each iteration. The results may allow a detailed ‘requirements’ specification to be produced for the planner automatically. By way of example, the results may indicate that the SUT needs a 1.5 second compute budget, plus a 20% reduction in perception error to meet some acceptable level of performance; those requirements may be reported to the user, who may act to improve the SUT based on the ablation analysis.

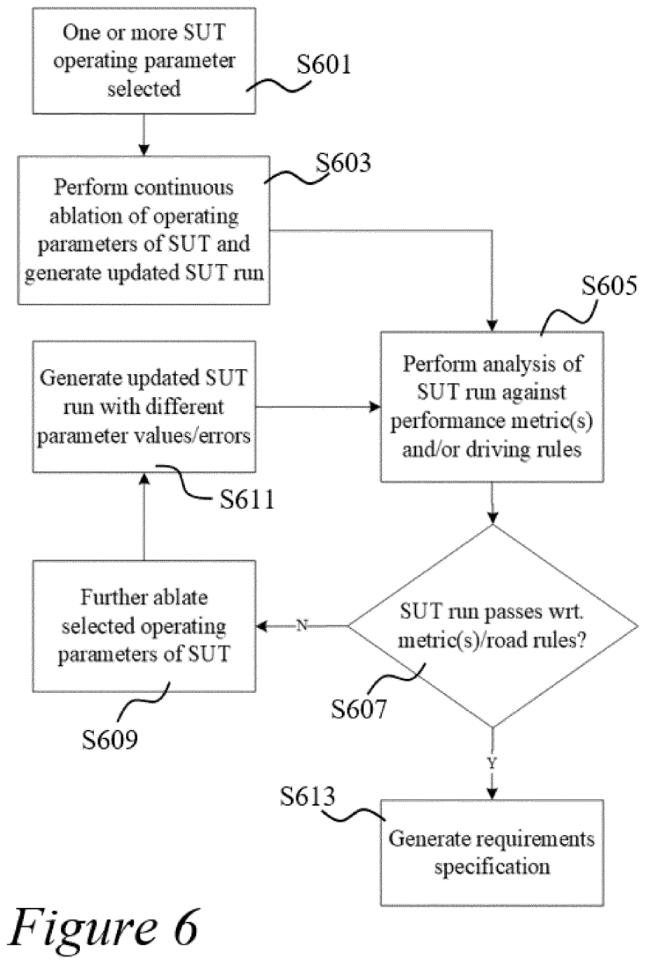

FIG. 6 shows an exemplary workflow for generating a requirements specification for an SUT using continuous ablation. In the exemplary workflow of FIG. 6, a run generated by an SUT has failed with respect to one or more performance metric and/or a set of road rules. The flow demonstrates a process of iterative ablation of one or more operating parameter to find a requirements specification for a particular SUT for a particular run. The exemplary workflow described herein implements an incremental increase in artificiality to determine a point at which the run no longer fails, and to generate a requirements specification. However, it will be appreciated that the operating parameters may be ablated according to different rules to achieve the same.

FIG. 6 begins at a step S601, wherein one or more operating parameter of the SUT is selected. The one or more selected operating parameter may include one or more perception parameter and/or one or more parameter of a different SUT component. At a step S603, a continuous ablation is performed on the selected operating parameters, such that an amount of artificiality is injected into the SUT with respect to the selected operating parameters. At a step S605 the SUT run, with ablated parameters, is analysed with respect to the one or more performance metric and/or the set of road rules with respect to which the unablated run failed.

At a step S607, a determination is made of whether the run, with ablated operating parameters, now passes with respect to the one or more performance metric and/or the set of road rules. If the run does not pass, the flow moves to a step S609, wherein the one or more operating parameter is further ablated. The flow then continues to a step S611, wherein an updates SUT run is generated using the operating parameters as ablated in step S609. The flow then returns to step S605, the step S605 being performed for the run generated in step S611. Note that the steps S605, S607, S609 and S611 may form a loop, wherein with each iteration, the artificiality of the SUT increases. After one or more iteration of the loop, it may be determined at step S607 that the SUT run passes with respect to the one or more performance metric and/or the set of road rules. If step S607 returns that the run passes, the flow may continue to a step S613, wherein a requirements specification may be generated. The requirements specification may tell a user which operating parameter values/errors must be improved, and by how much, before the SUT can generate a run that passes with respect to the one or more performance metric and/or the set of road rules.

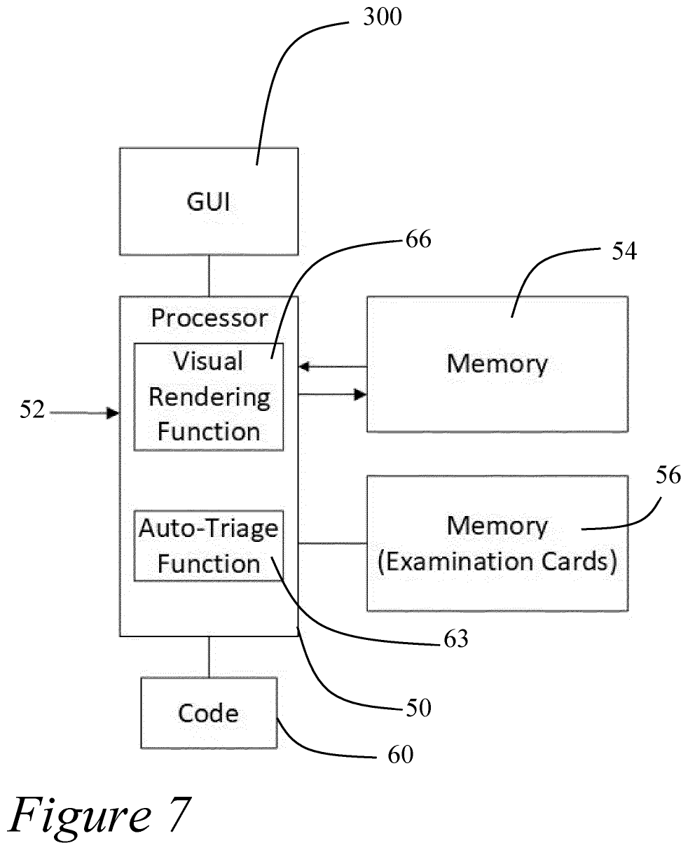

The above described steps are implemented in a computer system. Reference is made to FIG. 7, which illustrates a schematic block diagram of an example computer system (i.e. the introspective oracle 253) configured to utilise information (such as the above metrics) from real runs or simulated runs taken by an ego vehicle. A processor 50 receives data for generating insights into a system under test. The data is received at an input 52. A single input is shown, although it will readily be appreciated that any form of input to the introspective oracle may be implemented. In particular, it may be possible to implement the introspective oracle as a back-end service provided by a server, which is connected via a network to multiple computer devices which are configured to generate data and supply it to the introspective oracle. The processor 50 is configured to store the received data in a memory 54. Data is provided in the form of run data comprising “runs”, with their associated metrics, which are discussed further herein. The processor also has access to code memory 60 which stores computer executable instructions which, when executed by the processor 50, configure the processor 50 to carry out certain functions. The code which is stored in memory 60 could be stored in the same memory as the incoming data. It is more likely however that the memory for storing the incoming data will be configured differently from a memory 60 for storing code. Moreover, the memory 60 for storing code may be internal to the processor 50.

The processor 50 executes the computer readable instructions from the code memory 60 to execute various functions described herein. In particular, the processor 50 executes the instructions to perform the functions of generating first evaluation data of a first run by operating the autonomous robot under the control of a planning stack under test in a scenario; modifying at least one operating parameter of at least one component of the planning stack by applying a variable modification to the operating parameter; generate second evaluation data of a second run by operating the autonomous robot under the control of the planning stack in which the at least one operating parameter has been modified, in the scenario; and compare the first evaluation data with the second evaluation data using at least one performance metric for the comparison.

It will be appreciated that the memory 56 and the memory 54 could be provided by common computer memory or by different computer memories. The introspective oracle 253 further comprises a graphical user interface (GUI) 300 which is connected to the processor 50. The processor 50 may access examination cards which are stored in the memory 56 to render them on the graphical user interface 300 for the purpose further described herein. A visual rendering function 66 may be used to control the graphical user interface 300 to present the examination cards and associated information to a user.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A computer implemented method of evaluating the performance of at least one component of a planning stack for an autonomous robot, the method comprising:
generating first evaluation data of a first run by operating the autonomous robot under the control of a planning stack under test in a scenario;
modifying at least one operating parameter of at least one component of the planning stack by applying a variable modification to the operating parameter;
generating second evaluation data of a second run by operating the autonomous robot under the control of the planning stack in which the at least one operating parameter has been modified, in the scenario; and
comparing the first evaluation data with the second evaluation data using at least one performance metric for the comparison.

2. The method of claim 1, wherein the at least one component of the planning stack is a perception component, and wherein the variable modification is applied to the accuracy of perception by the perception component.

3. The method of claim 1, wherein the at least one component is a prediction component, and the variable modification is a modification of computational resources accessible for operating the prediction component in the planning stack.

4. The method of claim 1 wherein the at least one component is a control component.

5. The method of claim 1 wherein the variable modification is computed based on a statistical distribution of modification values for the parameter being modified.

6. The method of claim 5 wherein the statistical distribution is a Gaussian distribution.

7. The method of claim 1 wherein the variable modification to the operating parameter is applied responsive to user selection of a modification at a graphical user interface.

8. The method of claim 7 wherein the user selection comprises activating a slider on the graphical user interface which slides the percentage modification between first and second end points.

9. The method of claim 7 wherein the user selection selects a percentage variable modification to a plurality of the operating parameters.

10. The method of claim 1, wherein the scenario is a simulated scenario.

11. The method of claim 10 wherein the simulated scenario is based on ground truth extracted from an actual scenario in which the autonomous robot was operated.

12. The method of any preceding claim 1, wherein the comparing the first evaluation data with the second evaluation data uses juncture point recognition.

13. The method of claim 1, comprising displaying the result of the comparison as an indication on a performance card.

14. An apparatus comprising a processor; and a code memory storing a set of computer readable instructions, which when executed by the processor cause the processor to:
generate first evaluation data of a first run by operating the autonomous robot under the control of a planning stack under test in a scenario;
modify at least one operating parameter of at least one component of the planning stack by applying a variable modification to the operating parameter;
generate second evaluation data of a second run by operating the autonomous robot under the control of the planning stack in which the at least one operating parameter has been modified, in the scenario; and
compare the first evaluation data with the second evaluation data using at least one performance metric for the comparison.

15. A computer program comprising a set of computer readable instructions, which when executed by a processor, cause the processor to:
generate first evaluation data of a first run by operating the autonomous robot under the control of a planning stack under test in a scenario;
modify at least one operating parameter of at least one component of the planning stack by applying a variable modification to the operating parameter;
generate second evaluation data of a second run by operating the autonomous robot under the control of the planning stack in which the at least one operating parameter has been modified, in the scenario; and
compare the first evaluation data with the second evaluation data using at least one performance metric for the comparison.

16. The apparatus of claim 14, wherein the at least one component of the planning stack is a perception component, and wherein the variable modification is applied to the accuracy of perception by the perception component.

17. The apparatus of claim 14, wherein the at least one component is a prediction component, and the variable modification is a modification of computational resources accessible for operating the prediction component in the planning stack.

18. The apparatus of claim 14 wherein the at least one component is a control component.

19. The apparatus of claim 14, wherein the variable modification is computed based on a statistical distribution of modification values for the parameter being modified.

20. The apparatus of claim 18, wherein the statistical distribution is a Gaussian distribution.
